(19) United States
(12) Patent Application Publication
(10) Pub. No.: US 2026/0130538 A1
(43) Pub. Date: May 14, 2026

(54) Beverage Delivery Systems and Methods

(71) Applicant: Sharkbite Hydration, LLC, Blairstown, NJ (US)

(72) Inventor: Edward Alexander Bedford, Blairstown, NJ (US)

(73) Assignee: Sharkbite Hydration, LLC, Blairstown, NJ (US)

(21) Appl. No.: 19/481,189

(22) PCT Filed: May 4, 2024
(86) PCT No.: PCT/US2024/027893

§ 371 Date: Nov. 4, 2025

Related U.S. Application Data
(60) Provisional application No. 63/577,627, filed on May 5, 2023.
(60) Provisional application No. 63/612,463, filed on Dec. 20, 2023.

(51) Int. Cl. A47J 31/40; A47J 31/00; A47J 31/44

(52) U.S. Cl. CPC A47J 31/407; A47J 31/005; A47J 31/4403

(57) ABSTRACT

Beverage delivery systems and methods for use with a container and a sachet containing an ingredient include a top lid and a bottom lid, where the bottom lid engages said top lid in a manner that permits relative motion with the top lid and engages the container. The systems and methods include a pocket for receiving the sachet and a cutting mechanism for opening the sachet. Relative movement of the top lid and the bottom lid from a first position to a second position causes the cutting mechanism to engage and open the sachet in the pocket, releasing the ingredient from the sachet into the container.

### CROSS-REFERENCE TO RELATED APPLICATIONS

The present application claims priority to U.S. Provisional Patent Application Ser. No.

63/577,627 filed 5 May 2023 and claims priority to U.S. Provisional Patent Application Ser. No. 63/612,463 filed 20 Dec. 2023, the teachings and disclosures of each of which are incorporated by reference.

### BACKGROUND OF THE INVENTION

Traditional beverage mixing methods typically require manual opening of packets, which can be inefficient, messy, and imprecise. The existing systems often do not seamlessly integrate the opening and mixing functionalities, leading to potential spillage and contamination.

### SUMMARY OF THE INVENTION

Beverage delivery systems and methods for use with a container and a sachet containing an ingredient include a top lid and a bottom lid, where the bottom lid engages said top lid in a manner that permits relative motion with the top lid and engages the container. The systems and methods include a pocket for receiving the sachet and a cutting mechanism for opening the sachet. Relative movement of the top lid and the bottom lid from a first position to a second position causes the cutting mechanism to engage and open the sachet in the pocket, releasing the ingredient from the sachet into the container.

The disclosed beverage delivery system and methods are for use with a liquid container and a sachet containing an ingredient and comprise an integrated solution for efficiently opening sachets/containers/pouches containing concentrated ingredients and ensuring thorough mixing of these ingredients with a liquid.

The invention improves upon existing methods by offering multiple mechanical mechanisms for opening these containers, which are incorporated directly into the beverage container's lid.

These mechanisms provide a clean, fast, and efficient method for ingredient integration.

### BRIEF DESCRIPTION OF DRAWINGS

FIG. 1: An exploded view of the rotational embodiment of the device showing the rotational opening mechanism.

FIG. 2: An assembled view of the rotational embodiment of the device showing how the top and bottom lids'rotation relative to one another facilitates the opening of the sachet.

FIG. 3: An exploded view of the vertical press down embodiment of the device showing the vertical press down opening mechanism.

FIG. 4: An exploded cross-sectional view of the vertical press down embodiment of the device showing the vertical press down opening mechanism.

FIG. 5: An exploded view of the corkscrew embodiment of the device showing the vertical press down opening mechanism that facilitates a corkscrew cutting action.

FIG. 6: An assembled view of the corkscrew embodiment of the device showing how the top and bottom lids when moved vertically relative to one another facilitate a corkscrew action that opens the sachet.

### DETAILED DESCRIPTION OF THE INVENTION

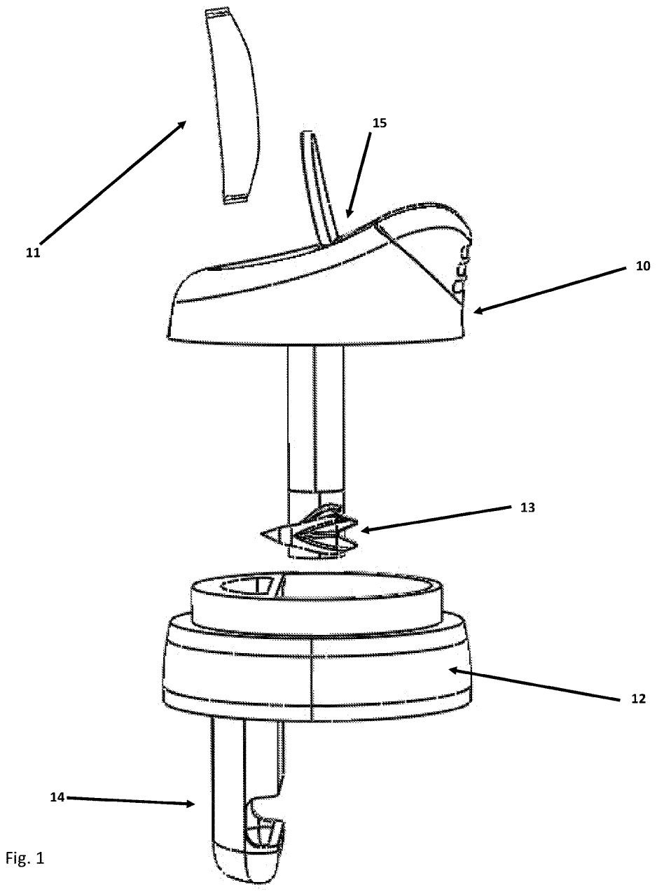

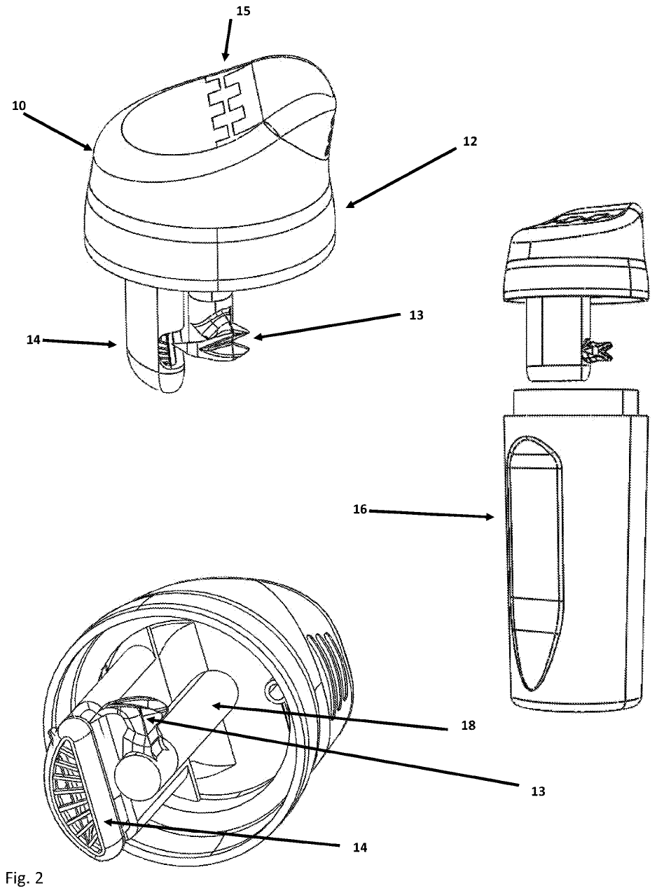

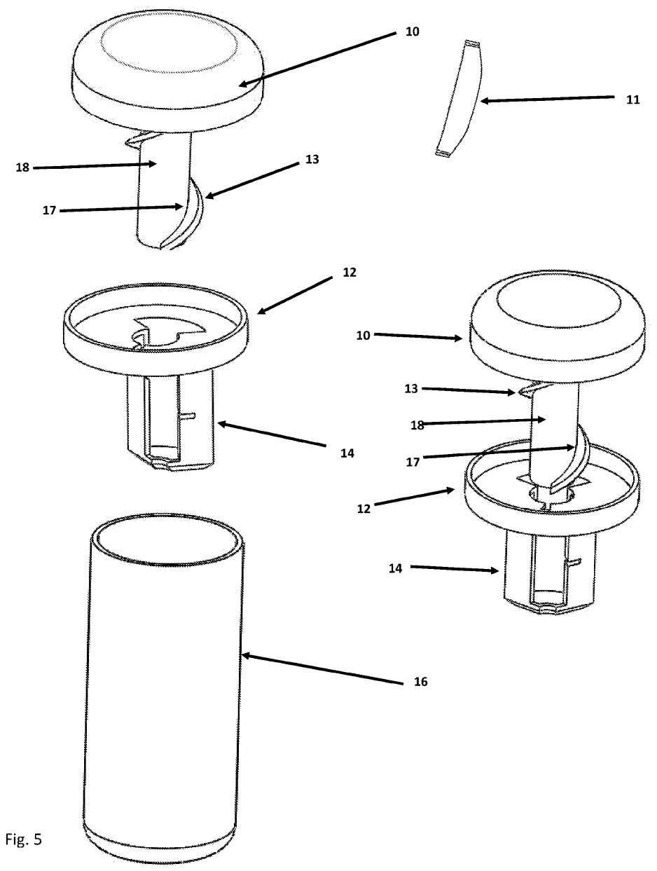

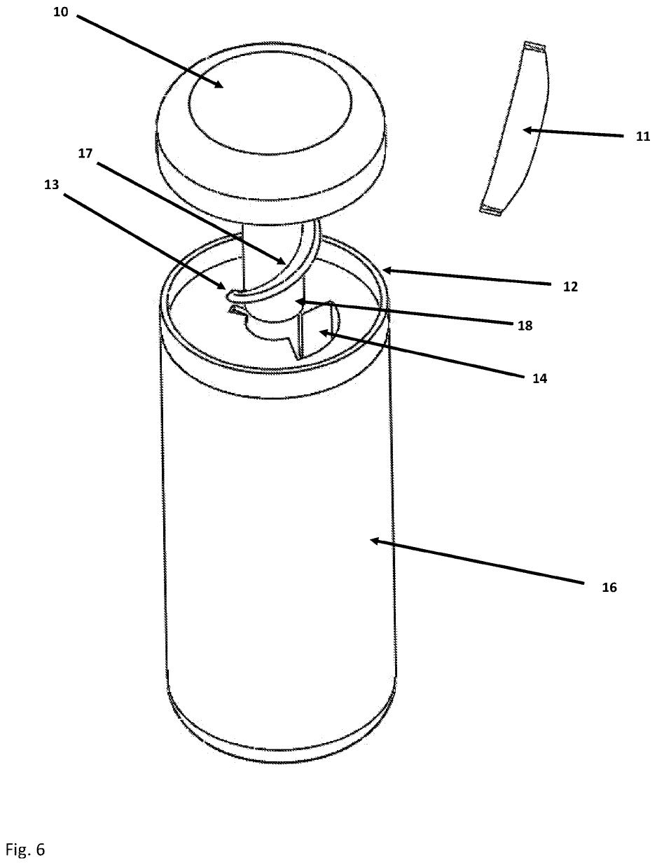

The following lists and describes the components of the embodiments of the device:
Top Lid (10): Can rotate, be pressed down or a combination to interact with the sachet. May include various cutting mechanisms (13) and may include the pocket (14) for holding the sachet (11). May include spring-assisted flap (15).
Sachet (11): The container for the concentrated ingredient. As used herein the term “sachet” includes any container, including but not limited to sachets, stickpacks, packets, pouches, capsules, or other thin-walled structures capable of containing an ingredient (not shown) and being pierced or punctured by a cutting mechanism. As used herein, “ingredient” includes one or more liquid, gel, or solid substances for flavoring and/or mixing with a liquid in a liquid container, including liquids, powders, and granules, as well as animal or vegetable matter, including concentrated or dehydrated versions of the same.
Bottom Lid (12): Supports the top lid and may contain the pocket (14) for holding the sachet (11). Engages with liquid container (16).
Cutting Mechanism (13): Includes rotating blades, corkscrew features, and fixed blades designed to engage and open the sachet (11). As used herein, “cutting mechanism” includes any knife edge, blade, or sharp feature capable of piercing, puncturing, cutting, penetrating the sachet (11) and may hold open sachet (11).
Pocket (14): Holds the sachet (11) during the opening process, and may loosely or securely hold the sachet (11), including by having a form that is form-fitting with the sachet (11). Includes baskets or other shapes suitable for holding the sachet. May include a screen or other structure for retaining the sachet and permitting the ingredient to pass through.
Spring assisted flap (15): May include an overmolded leaf spring (not shown) acting as a closure for sealing an opening in top lid (10).
Liquid Container (16): The main container for containing a liquid into which the ingredient is released.
Corkscrew Feature (17): may be part of shaft (18) and includes cutting mechanism (13) along its edge.
Shaft (18) may include a fixed cutting mechanism (13), see FIGS. 1-2, or a corkscrew feature (17), see FIGS. 5-6.

Operational Method: Users can operate the device by either rotating the top lid (10) or pressing it down, depending on the design variant used, as described in more detail below.

These actions engage the cutting mechanisms (13), which open the sachet (11) and allow the ingredient to mix with the liquid in liquid container (16) below bottom lid (12).

After opening, the device may be shaken to further integrate the ingredient with the liquid in the liquid container (16).

FIG. 1, and 3-6 each show an example sachet (11) for use in all embodiments of the invention.

FIGS. 1-2 show a device including a rotational embodiment of the invention.

The sachet (11) is inserted in through the spring flap (15) of the top lid (10) where it is held vertically by way of a form fitting pocket (14) in bottom lid (12). Top lid (10) is rotationally mounted to bottom lid (12) and includes an opening for receiving the sachet, and a shaft (18) on which cutting mechanism (13) is mounted. Bottom lid (12) includes an opening for receiving shaft (18) of top lid (10).

Then the top lid (10) rotated with respect to bottom lid (12). The physical act of doing this facilitates the opening of sachet/container/pouch (11) by moving rotationally relative to cutting mechanism (13) that enters an opening in pocket (14) and cuts and holds open the sachet (11), thus releasing the ingredient from the sachet (11) into the container below (16).

Cutting mechanism (13) is configured as a sharp point (for puncturing sachet (11)) that splits into a clamshell shaped dual cutting edges (for slicing sachet (11)).

Top lid (10) features spring assisted lid (15) that uses an over molded spring steel leaf spring (not shown), thus eliminating any crevices for bacterial growth.

As assembled, top lid (10) is rotationally mounted to bottom lid (12), and bottom lid (12) is secured to liquid container (16). The user would open the spring lid (15) and insert the sachet (11) into pocket (14). They would then close the spring lid (15) and rotate top lid (10) clockwise about a vertical axis relative to bottom lid (12) thus facilitating the cutting mechanism (13) to tear open the sachet (11) releasing it contents (ingredient) into the water filled liquid container (16) below. The user would then shake the device to thoroughly mix the contents together before drinking.

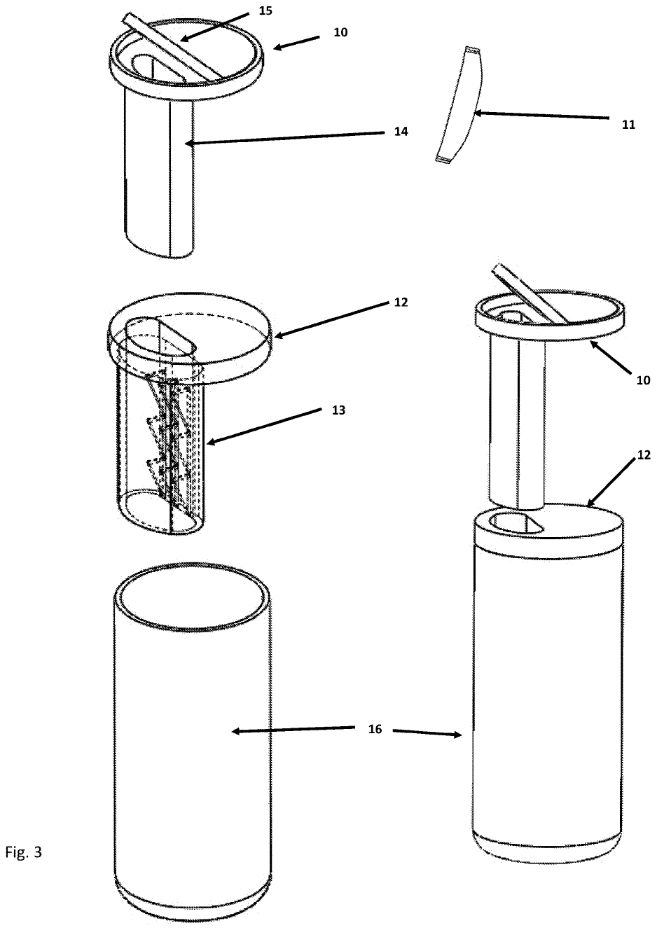

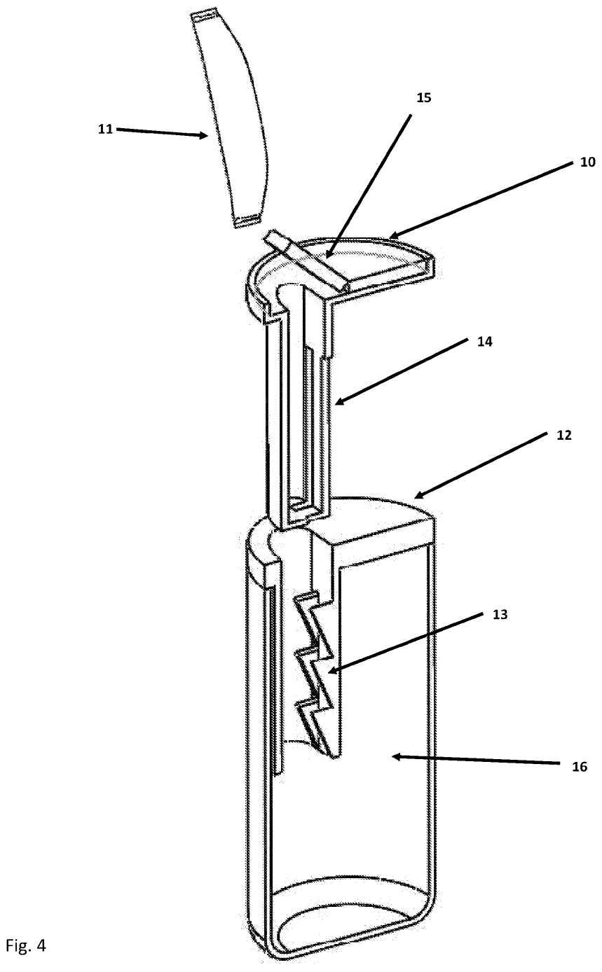

FIGS. 3-4 show a device including a press-down embodiment of the invention.

The sachet (11) is inserted in through the top of the top lid (10) where it is held vertically by way of a form fitting pocket (14) in top lid (10). Top lid (10) may include spring-assisted lid or flap (15) for sealing an opening in top lid. Pocket (14) fits with a sleeve of bottom lid (12) on which cutting mechanism (13) is fixed. Cutting mechanism (13) is vertically aligned and fits within slots in pocket (14).

Then top lid (10) is pressed down to bottom lid (12). The physical act of doing this facilitates the opening of sachet (11) by moving vertically down relative to cutting mechanism (13), which is a saw-tooth shaped fixed cutting tooth or blade that cuts and holds open the sachet (11), thus releasing the ingredient from the sachet (11) into the liquid container (16) below bottom lid (12).

FIGS. 5-6 show a device including a corkscrew embodiment of the invention.

The sachet (11) is inserted into the form fitting pocket (14) of bottom lid (12) where it is held vertically by way of form fitting pocket (14) in bottom lid (12).

Then the top lid (10) is pressed down to bottom lid (12). The physical act of doing this facilitates a rotation of shaft (18) which includes cutting mechanism (13) and corkscrew feature (17) on which cutting mechanism (13), which is a helical tooth or blade, is mounted to an edge of corkscrew feature (17).

The corkscrew feature (17) is rotationally mounted to top lid (10) and when top lid (10) is pressed down, shaft (18) rotates relative to the top lid (10) and bottom lid (12).

By corkscrew action, cutting mechanism (13) rotates about the vertical axis and cuts the sachet (11), thus releasing the ingredient from the sachet (11) into the liquid container (16) below bottom lid (12).

While the invention has been illustrated and described in detail in the drawings and foregoing description, the same is to be considered as illustrative and not restrictive in character, it being understood that only the preferred embodiments have been shown and described and that all changes, equivalents, and modifications that come within the scope or spirit of the inventions defined by following claims are desired to be protected. It is also contemplated that structures and features embodied in the present examples can be altered, rearranged, substituted, deleted, duplicated, combined, and added to each other. The articles “the,” “a”, and “and” are not necessarily limited to mean only one, but rather are inclusive and open-ended so as to optionally include optionally multiples of such elements.

1. A beverage delivery system for use with a container and a sachet containing an ingredient, comprising:
a. a top lid;
b. a bottom lid adapted to
i. engage said top lid in a manner permitting relative motion therewith, and
ii. engage the container;
c. a pocket for receiving the sachet; and
d. a cutting mechanism for opening the sachet;
e. wherein relative movement of the top lid and the bottom lid from a first position to a second position causes
i. said cutting mechanism to engage the sachet received in said pocket,
ii. said cutting mechanism to open said sachet, and
iii. release the ingredient from the sachet into the container.

2. The beverage delivery system of claim 1, wherein said relative movement includes translation.

3. The beverage delivery system of claim 2, wherein said top and bottom lids are aligned along a longitudinal axis, said cutting mechanism includes a longitudinally aligned cutting edge, and said cutting mechanism is adapted to engage and open the sachet as said top lid is translated relative to said bottom lid.

4. The beverage delivery system of claim 2, wherein
a. said relative movement further includes rotation,
b. said top lid includes a corkscrew feature adapted to engage a slot in said bottom lid,
c. said top and bottom lids are aligned along a longitudinal axis, said corkscrew feature includes said cutting mechanism along an edge, and
d. said cutting mechanism is adapted to engage and open the sachet as said corkscrew feature of said top lid is translated and rotated in helical motion relative to said bottom lid.

5. The beverage delivery system of claim 1, wherein said relative movement includes rotation.

6. The beverage delivery system of claim 5, wherein said top and bottom lids are aligned along a longitudinal axis, said cutting mechanism includes a laterally aligned cutting edge, and said cutting mechanism is adapted to engage and open the sachet as said top lid is rotated relative to said bottom lid.

7. The beverage delivery system of claim 1 wherein said top lid further includes
a. an opening for receiving the sachet, and
b. a closure mechanism for closing said opening including an overmolded leaf spring.

8. A beverage delivery system for use with a container and a sachet containing an ingredient, comprising:
a. a top lid;
b. a bottom lid adapted to
i. engage said top lid in a manner permitting relative rotational motion therewith, and
ii. engage the container;
c. said bottom lid including a pocket for receiving the sachet; and
d. said top lid including a cutting mechanism for opening the sachet;
e. wherein relative rotational movement of the top lid and the bottom lid from a first position to a second position causes
i. said cutting mechanism to engage the sachet received in said pocket,
ii. said cutting mechanism to open said sachet, and
iii. release the ingredient from the sachet into the container; and
f. wherein said top and bottom lids are aligned along a longitudinal axis, said cutting mechanism includes a cutting edge, and said cutting mechanism is adapted to engage and open the sachet as said top lid is rotated relative to said bottom lid.

9. The beverage delivery system of claim 8 wherein said cutting mechanism is mounted on a shaft extending distally through said bottom lid from a laterally-extending surface of said top lid, said shaft concentric with said longitudinal axis.

10. The beverage delivery system of claim 9, wherein said pocket includes an opening adapted to engage said cutting mechanism

11. The beverage delivery system of claim 8 wherein said pocket extends distally from a laterally-extending surface of said bottom lid offset from said longitudinal axis.

12. The beverage delivery system of claim 11 wherein said pocket further includes an opening at its distal end for permitting passage of the ingredient, and further including a retaining screen for retaining said sachet.

13. The beverage delivery system of claim 8 wherein said cutting edge is laterally aligned.

14. The beverage delivery system of claim 8 wherein said top lid further includes
a. an opening for receiving the sachet, and
b. a closure mechanism for closing said opening including an overmolded leaf spring.

15. The beverage delivery system of claim 9, wherein
a. said relative movement further includes rotation,
b. said pocket extends distally from a laterally extending surface of said bottom lid offset from said longitudinal axis and includes a slot,
c. said top lid includes a corkscrew feature rotationally mounted on said shaft and adapted to engage said slot,
d. said top and bottom lids are aligned along a longitudinal axis, said corkscrew feature includes said cutting mechanism along an edge, and
e. said cutting mechanism is adapted to engage and open the sachet as said top lid is translated and said shaft is rotated in helical motion relative to said bottom lid.

16. A beverage delivery system for use with a container and a sachet containing an ingredient, comprising:
a. a top lid;
b. a bottom lid adapted to
i. engage said top lid in a manner permitting relative translational motion therewith, and
ii. engage the container;
c. said top lid including a pocket for receiving the sachet; and
d. said bottom lid including a cutting mechanism for opening the sachet;
e. wherein relative translational movement of the top lid and the bottom lid from a first position to a second position causes
i. said cutting mechanism to engage the sachet received in said pocket,
ii. said cutting mechanism to open said sachet, and
iii. release the ingredient from the sachet into the container; and
f. wherein said top and bottom lids are aligned along a longitudinal axis, said cutting mechanism includes a longitudinally aligned cutting edge, and said cutting mechanism is adapted to engage and open the sachet as said top lid is translated relative to said bottom lid.

17. The beverage delivery system of claim 16 wherein said cutting mechanism is mounted on a sleeve extending distally through said bottom lid from a laterally extending surface of said bottom lid, said shaft offset from said longitudinal axis.

18. The beverage delivery system of claim 17 wherein said pocket extends distally from a laterally extending surface of said top lid offset from said longitudinal axis, and adapted to slidingly engage said sleeve.

19. The beverage delivery system of claim 16, wherein said pocket includes a longitudinally aligned opening adapted to engage said cutting mechanism.

20. The beverage delivery system of claim 16, wherein said cutting mechanism is formed in a saw-tooth shape.
